(19) United States
(12) Patent Application Publication
(10) Pub. No.: US 2026/0225506 A1
(43) Pub. Date: Aug. 6, 2026

(54) UTILITY VEHICLE

(71) Applicant: KAWASAKI MOTORS, LTD., Akashi-shi (JP)

(72) Inventor: Akihiro FUKUMOTO, Akashi-shi (JP)

(73) Assignee: KAWASAKI MOTORS, LTD., Akashi-shi (JP)

(21) Appl. No.: 19/396,373

(22) Filed: Nov. 21, 2025

(30) Foreign Application Priority Data
Feb. 4, 2025 (JP) 2025-016645

(51) Int. Cl. B60N 2/68; B60N 2/64; B60R 5/04; B60R 22/26

(52) U.S. Cl. CPC B60N 2/68; B60N 2/64; B60R 5/04; B60R 22/26; B60R 2022/266

(57) ABSTRACT

A utility vehicle includes a seat on which an occupant is seated and a seat frame. The seat includes a cushion material and a seat bottom plate to which the cushion material is attached. The seat bottom plate includes: a positioning abutment portion that abuts on the seat frame, prevents movement in one predetermined direction perpendicular to a vertical direction with respect to the seat frame, and allows rotation with an abutment position with the seat frame as a fulcrum; and an engaging portion that is engaged with the seat frame in the vertical direction at a predetermined seating rotation position with respect to the seat frame while the positioning abutment portion abuts on the seat frame.

### CROSS-REFERENCE TO RELATED APPLICATION

The present application claims priority of Japanese Patent Application No.: 2025-016645 filed on Feb. 4, 2025, the content of which is incorporated herein by reference.

### BACKGROUND

### Technical Field The present disclosure relates to a utility vehicle.

### Background Art

A utility vehicle includes a seat on which an

occupant is seated in a vehicle cabin, and the seat is attached to a seat frame supported by a vehicle body frame. US 2012/0160586 A discloses a utility vehicle in which a seat is attached to a seat frame.

### SUMMARY

The seat described in US 2012/0160586 A has a structure detachable from the seat frame.

An object of the present disclosure is to simplify a fixing structure for fixing a seat to a seat frame.

The present disclosure provides a utility vehicle including: a seat on which an occupant is seated, the seat including a cushion material and a seat bottom plate to which the cushion material is attached; and a seat frame to which the seat bottom plate is attached, in which the seat bottom plate includes: a positioning abutment portion that abuts on the seat frame to prevent movement in one predetermined direction perpendicular to a vertical direction with respect to the seat frame and to allow rotation with an abutment position with the seat frame as a fulcrum; and an engaging portion that is engaged with the seat frame in the vertical direction at a predetermined seating rotation position with respect to the seat frame while the positioning abutment portion abuts on the seat frame.

The present disclosure also provides a utility vehicle including: a seat on which an occupant is seated; a seat frame disposed below the seat; a seat belt capable of restraining the occupant seated on the seat; and a belt anchor to which one end portion of the seat belt is fixed, in which the seat includes a seat cutout portion through which a portion of the seat belt is inserted, and the belt anchor is fixed to the seat frame below the seat cutout portion.

The present disclosure also provides a utility vehicle including: a ROPS frame that defines an upper portion of a riding space; a seat disposed in the riding space; and a seat back disposed in the riding space, in which the ROPS frame includes a pair of left and right vertical frames extending in a vertical direction on an outer side in a vehicle width direction, and an outer portion of the seat back in the vehicle width direction directly or indirectly abuts on the vertical frames.

### BRIEF DESCRIPTION OF THE DRAWINGS

FIG. 1 is a side view of a utility vehicle according

to the present embodiment;

FIG. 2 is a perspective view of a vehicle body frame of the utility vehicle;

FIG. 3 is a rear perspective view of the utility vehicle;

FIG. 4 is a rear perspective view of the utility vehicle from which a seat is removed;

FIG. 5 is a top view of the seat;

FIG. 6 is a bottom view of the seat;

FIG. 7 is a cross-sectional view of the seat and a seat frame;

FIG. 8 is a view illustrating a positioning abutment portion of the seat;

FIG. 9 is a view illustrating an engaging portion of the seat;

FIG. 10 is a view illustrating a guide portion of the seat;

FIG. 11 is a view illustrating a belt anchor;

FIG. 12 is a perspective view illustrating an abutment portion between a ROPS frame and a seat back of the seat; and

FIG. 13 is a perspective view of the vicinity of a battery including an electric shock preventing member.

### DETAILED DESCRIPTION OF EMBODIMENTS

Hereinafter, a utility vehicle according to an embodiment of the present disclosure will be described with reference to the accompanying drawings. The utility vehicle is mainly a vehicle for traveling not only on a grass field, a gravel field, and a sandy field but also on an off road such as an unpaved mountain road or forest road, a muddy road, and a rocky field. Note that in the present specification, “front”, “rear”, “upper”, “lower”, “left”, and “right” refer to a front direction, a rear direction, an upper direction, a lower direction, a left direction, and a right direction as viewed from a driver on the utility vehicle.

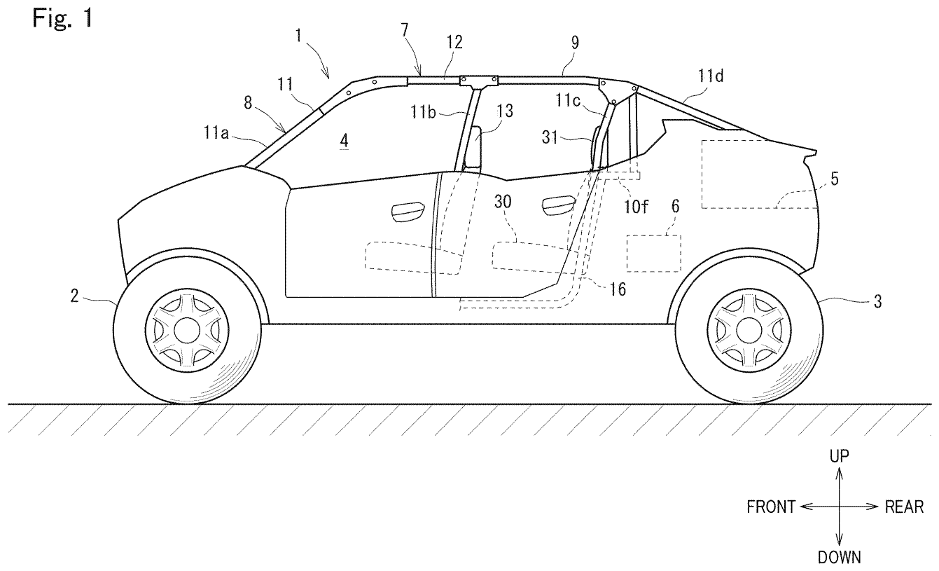

FIG. 1 is a side view of the utility vehicle according to the present embodiment. As illustrated in FIG. 1, a utility vehicle 1 includes a pair of left and right front wheels 2 at a front portion of a vehicle body, a pair of left and right rear wheels 3 at a rear portion of the vehicle body, and a riding space (vehicle cabin) 4 between the front wheels 2 and the rear wheels 3 for occupants including a driver to ride. A cargo bed 5 is provided behind the riding space 4, and a drive source 6 such as an engine is provided below the cargo bed 5. Power from the drive source 6 is transmitted to the rear wheels 3 and to the front wheels 2.

The riding space 4 is surrounded by a ROPS frame 7. The ROPS is an abbreviation for a rollover protection structure. The ROPS frame 7 is provided to protect occupants in a case where the vehicle falls. The ROPS frame 7 may be a portion of a vehicle body frame 8. In the present embodiment, the ROPS frame 7 is formed with a metal pipe.

The utility vehicle 1 may include low-pressure tires as the front wheels 2 and the rear wheels 3 for traveling on an uneven ground. The utility vehicle 1 does not have to include the cargo bed 5, but preferably includes the cargo bed 5. The utility vehicle 1 is preferably provided with a housing space below the seat, and the seat is preferably detachable so as to be accessible to the housing space.

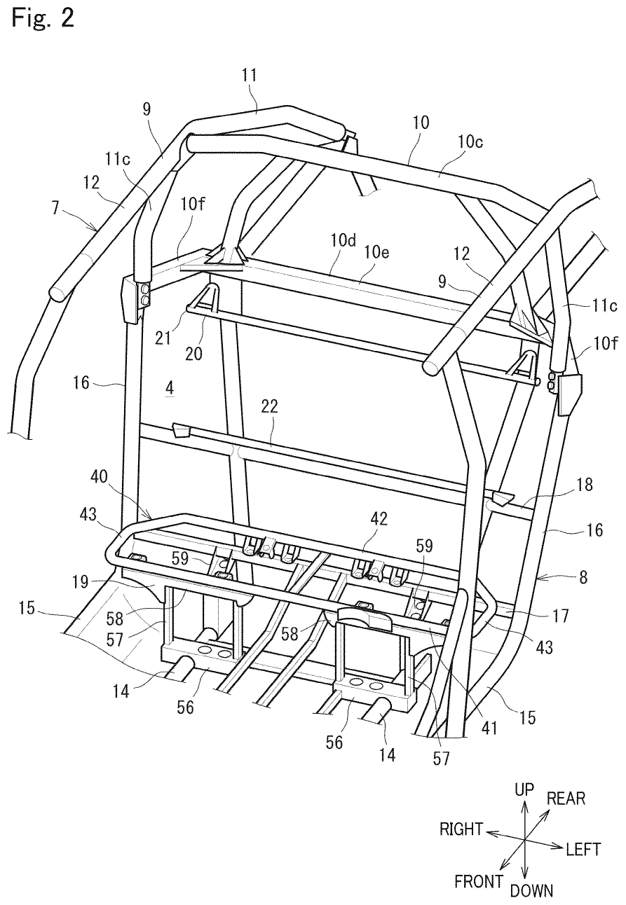

FIG. 2 is a perspective view of the vehicle body frame of the utility vehicle. As illustrated in FIG. 2, the ROPS frame 7 includes a pair of left and right side frames 9 disposed on both sides of the riding space 4, and a cross member 10 extending in the vehicle width direction between the pair of left and right side frames 9.

The side frame 9 includes a plurality of vertical frames 11 extending in the vertical direction, and an upper frame 12 connecting upper end portions of the plurality of vertical frames 11 and extending in the front-rear direction. As illustrated in FIG. 1, the vertical frames 11 include a first vertical frame 11a, a second vertical frame 11b, a third vertical frame 11c, and a fourth vertical frame 11d which are sequentially arranged at intervals from the front side of the vehicle body.

The cross member 10 includes a first cross member connecting lower end portions of the left and right first vertical frames 11a, a second cross member connecting upper end portions of the left and right first vertical frames 11a, a third cross member 10c connecting upper end portions of the left and right third vertical frames 11c, and a fourth cross member 10d connecting lower end portions of the left and right third vertical frames 11c.

The first cross member, the second cross member, and the third cross member 10c linearly extend substantially in the vehicle width direction in top view. A dimension in the vehicle width direction of a rear region of the riding space 4 decreases toward a rear side. Thus, both sides of the fourth cross member 10d on the outer side in the vehicle width direction extend forward toward the outer side in the vehicle width direction. In other words, the fourth cross member 10d includes a linear portion 10e located on the center side in the vehicle width direction and extending linearly along the vehicle width direction, and an inclined portion 10f located on the outer side in the vehicle width direction and inclined forward toward the outer side in the vehicle width direction.

As illustrated in FIG. 1, a front seat 13 on which an occupant is seated is disposed in a front portion of the riding space 4, and a rear seat 30 on which the occupant is seated is disposed in a rear portion of the riding space 4. The front seat 13 is a pair of left and right separate-type seats, and the rear seat 30 is a bench-type seat. The seat serves as a portion that supports the buttocks of the occupant in a seated state from below.

In the separate-type seat, one person can sit on the seat, and the seat serving as a seat bottom and a seat back serving as a backrest portion are connected to each other. The bench-type seat has a lateral width dimension allowing two or more people to sit. The bench-type seat has a seat 30 that extends leftward and rightward and is a single seat bottom for a plurality of people. In the present embodiment, a seat back 31 is provided above the seat 30. The seat back 31 is separated from the seat 30 in the vertical direction behind the seat 30 and is separate from the seat 30. The seat back 31 is a portion that supports the back of the occupant in the seated state from behind.

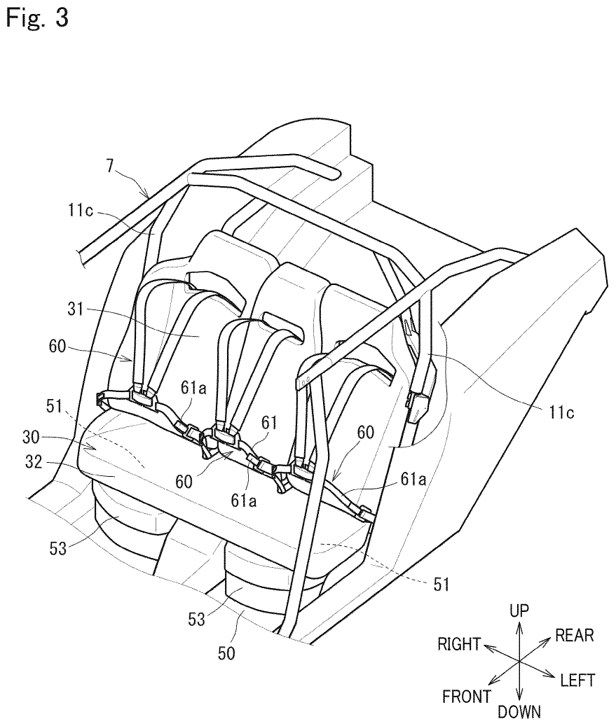

FIG. 3 is a rear perspective view of the utility vehicle. As illustrated in FIG. 3, an outer edge portion of the seat back 31 in the vehicle width direction is directed forward toward the outer side in the vehicle width direction. The outer edge portion of the seat back 31 in the vehicle width direction is a portion that supports a side portion of the occupant adjacent to an inner side of the outer edge portion in the vehicle width direction, that is, a shoulder portion, a waist portion, and the like, from the outer side in the vehicle width direction.

The frame 11c is located behind the outer edge portion of the seat back 31 in the vehicle width direction, and is located ahead of a center portion that is a seat back main body portion in the vehicle width direction except the outer edge portion of the seat back 31 in the vehicle width direction. The seat back main body portion is located as rearward as possible to expand the riding space and prevent interference between the frame 11c and the seat back 31.

The seat of the utility vehicle 1 according to the present embodiment is applied to the rear seat 30. The rear seat 30 will be described below, but may be applied to the front seat 13.

The seat 30 is formed longer in the vehicle width direction than in the front-rear direction. The seat 30 includes a cushion material 32 and a seat bottom plate 33 which is disposed below the cushion material 32 and to which the cushion material 32 is attached. For example, the cushion material 32 is formed with a foam material, or the like. The cushion material 32 is preferably covered with a skin material, but does not have to include a skin material. For example, the seat bottom plate 33 is formed with a metal, a resin, or the like.

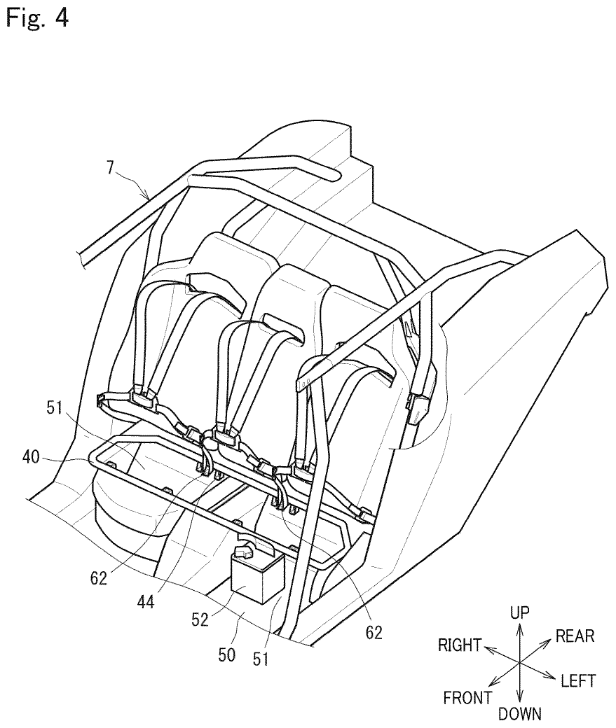

FIG. 4 is a rear perspective view of the utility vehicle from which the seat is removed. The seat 30 is detachably attached to the seat frame 40. As illustrated in FIG. 4, a floor panel 50 that defines a lower side of the riding space 4 is disposed below the seat 30, and the seat frame 40 is attached to the vehicle body frame 8 via the floor panel 50. The seat frame 40 may be directly attached to the vehicle body frame 8 without interposing the floor panel.

A housing space 51 in which articles are housed is provided between the seat 30 and the floor panel 50 in the vertical direction. By removing the seat 30, an operator can access a battery 52 disposed in the housing space 51. The housing space 51 may be provided with a storage capable of housing the luggage of the occupant in addition to the battery.

As illustrated in FIG. 2, the vehicle body frame 8 includes a pair of left and right main floor frames 14 and side floor frames 15 extending in the front-rear direction of the vehicle body. The left and right main floor frames 14 and the side floor frames 15 are provided substantially symmetrically in the vehicle width direction.

A support frame 16 extending in the vertical direction and supporting the ROPS frame 7, specifically, the third vertical frame 11c is integrally formed at rear portions of the left and right side floor frames 15. The support frame 16 is coupled to a lower end portion of the third vertical frame 11c.

A first support cross frame 17 extending in the vehicle width direction is provided between lower portions of the left and right support frames 16. A second support cross frame 18 extending in the vehicle width direction is provided between center portions of the left and right support frames 16. A fourth cross member 10d is provided between upper portions of the left and right support frames 16. The fourth cross member 10d is disposed behind the rear seat 30.

Support brackets 56 extending in the vehicle width direction are attached to the left and right main floor frames 14. Support vertical frames 57 extending upward in the substantially vertical direction are attached to both end portions of the support brackets 56, and mounting brackets 58 extending linearly in the vehicle width direction in the substantially horizontal direction are attached to upper end portions of the support vertical frames 57. Through holes for attaching the seat frame 40 are formed in the mounting brackets 58, and nuts are welded so as to correspond to the through holes.

A first support cross frame 17 linearly extending in the vehicle width direction in the substantially horizontal direction is disposed behind the mounting brackets 58. Through holes for attaching the seat frame 40 are formed in the first support cross frame 17, and nuts are welded so as to correspond to the through holes. The mounting brackets 58 are connected to the first support cross frame 17 by connection brackets 59. The mounting brackets 58 and the first support cross frame 17 constitute a seat mounting frame 19.

The seat frame 40 is attached to the seat mounting frame 19. The seat frame 40 is formed with a metal pipe having a circular cross section. The seat frame 40 includes a front frame 41 extending in the vehicle width direction and supporting a front side of the seat bottom plate 33 from below, a rear frame 42 extending in the vehicle width direction and supporting a rear side of the seat bottom plate 33 from below, and a connection frame 43 extending in the front-rear direction and connecting the front frame 41 and the rear frame 42. The connection frame 43 is provided so as to connect both end portions of the front frame 41 and the rear frame 42. The seat frame 40 has a circular cross section, but may have another shape such as a quadrangular cross section.

A plurality of fixing brackets 44 are fixedly attached to the seat frame 40. The seat frame 40 is fixedly attached to the vehicle body frame 8, specifically, the seat mounting frame 19 by screwing fastening bolts inserted into the fixing brackets 44 into nuts through the through holes of the mounting brackets 58 and the first support cross frame 17. The seat frame 40 is attached to the vehicle body frame 8 via the floor panel 50, and the floor panel 50 has bolt insertion holes corresponding to the through holes of the mounting brackets 58 and the first support cross frame 17.

Two housing spaces 51 are formed in the rear portion of the floor panel 50 in the vehicle width direction. The housing space 51 has a bottom surface, side surfaces on both sides, and a rear surface defined by the floor panel 50, an upper surface defined by the seat 30, and a front surface defined by a front cover 53. The front cover 53 is detachably attached to the floor panel 50. The operator can access the housing space 51 from the upper surface and the front surface by removing the seat 30 and the front cover 53.

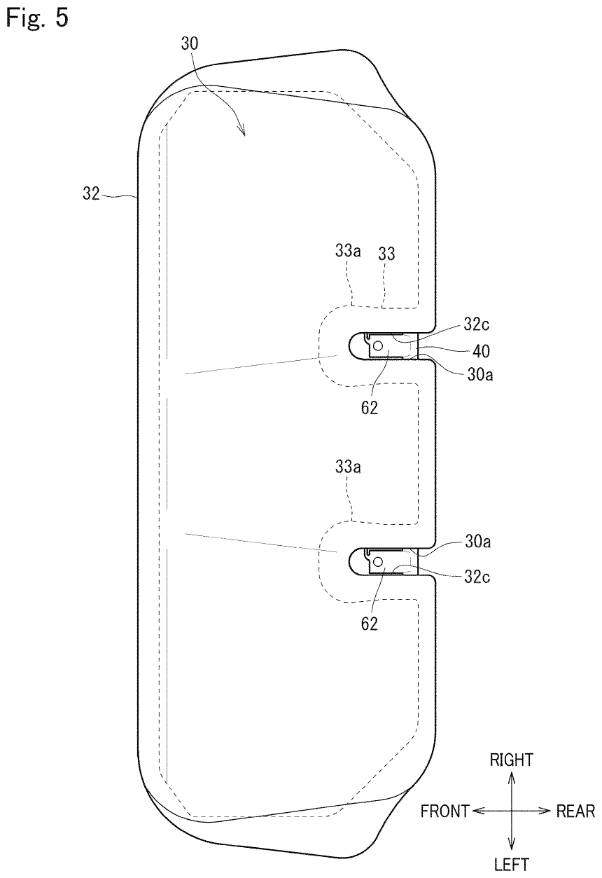

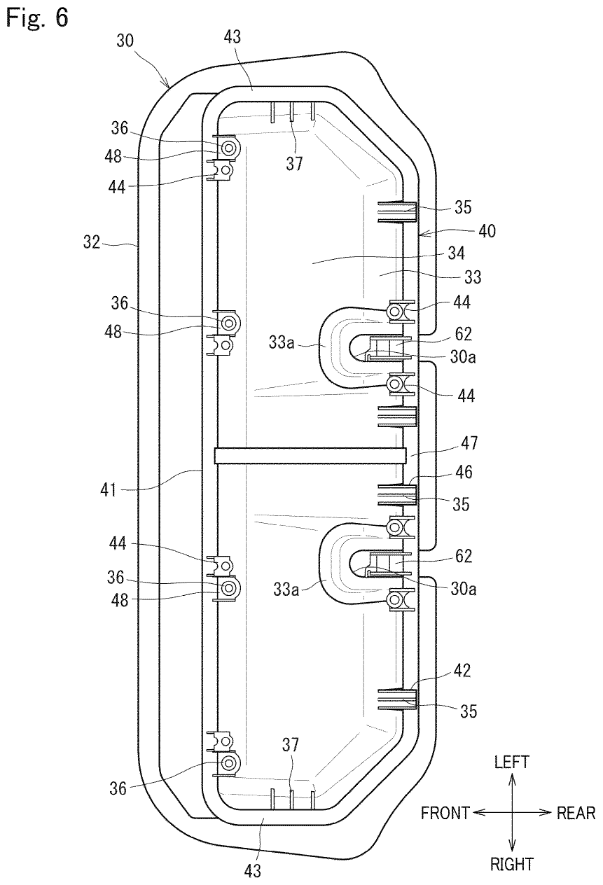

FIG. 5 is a top view of the seat. FIG. 6 is a bottom view of the seat. FIGS. 5 and 6 also illustrate the seat frame 40. As illustrated in FIG. 5, two seat cutout portions 30a are formed in an elongated hole shape in the rear portion of the seat 30. In the case of the seat for three, the two seat cutout portions 30a are located on both sides of a seating position of the occupant in the middle. A portion of the seat belt 61 is inserted into the seat cutout portion 30a.

As illustrated in FIG. 6, the seat bottom plate 33 of the seat 30 attached to the seat frame 40 is formed in a substantially rectangular shape in a bottom view, and includes a bottom plate main body portion 34 formed in a plate shape.

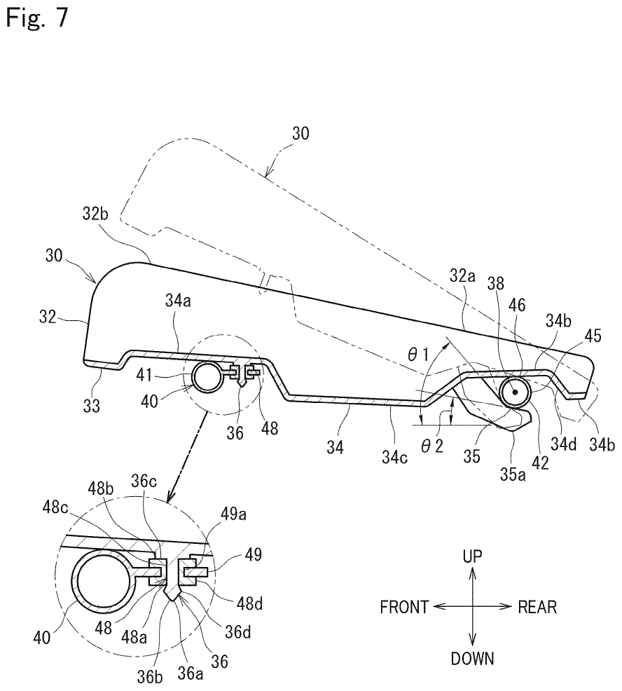

FIG. 7 is a cross-sectional view of the seat and the seat frame. As illustrated in FIG. 7, the seat bottom plate 33 includes a positioning abutment portion 35 and an engaging portion 36. The positioning abutment portion 35 abuts on the seat frame 40 to prevent movement in one predetermined direction perpendicular to the vertical direction with respect to the seat frame 40, specifically, rearward movement. The positioning abutment portion 35 abuts on the seat frame 40 from the front side to prevent the seat 30 from moving rearward with respect to the seat frame 40. The positioning abutment portion 35 abuts on the seat frame 40 having a circular cross section. With such a configuration, in a state where the positioning abutment portion 35 abuts on the seat frame 40, the positioning abutment portion 35 allows rotation around a rotation axis 38 which extends parallel to the seat frame 40 with the abutment position on the seat frame 40 as a fulcrum.

The engaging portion 36 is vertically engaged with the seat frame 40 at a predetermined seating rotation position with respect to the seat frame 40 while the positioning abutment portion 35 abuts on the seat frame 40. As a result of the engaging portion 36 being engaged with the seat frame 40 in the vertical direction, positional displacement in the left-right direction and the front-rear direction can be prevented. The seating rotation position is a position where the occupant can sit as a seat. The seating rotation position is a position where the seat bottom plate 33 is supported from below by the front frame 41 and the rear frame 42. In the present embodiment, the positioning abutment portion 35 and the engaging portion 36 are integrally molded with the seat bottom plate 33. The positioning abutment portion and the engaging portion may be formed separately from the seat bottom plate 33 and fixed to the seat bottom plate 33.

As illustrated in FIG. 6, the positioning abutment portion 35 is provided on the rear side of the seat bottom plate 33. A plurality of, specifically, four positioning abutment portions 35 are provided at intervals in the vehicle width direction which is a direction orthogonal to the vertical direction and the front-rear direction. A plurality of, specifically, four engaging portions 36 are provided on the front side of the seat bottom plate 33 in the vehicle width direction. The positioning abutment portions 35 and the engaging portions 36 are arranged in a dispersed manner in the vehicle width direction of the seat frame 40. In the present embodiment, the four positioning abutment portions 35 are arranged at the same position in the vertical direction and the front-rear direction, and the four engaging portions 36 are arranged at the same position in the vertical direction and the front-rear direction.

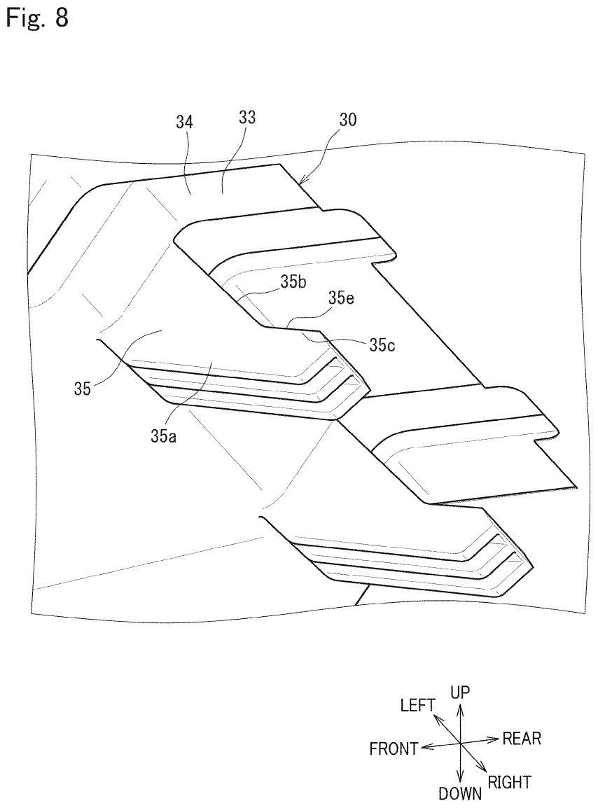

FIG. 8 is a view illustrating the positioning abutment portion of the seat. As illustrated in FIG. 8, the positioning abutment portion 35 includes a claw portion 35a protruding rearward and downward in an inclined manner from the bottom plate main body portion 34. An upper surface of the claw portion 35a includes a first inclined portion 35b that is inclined downward at a first angle θ1 with respect to a horizontal plane in a state where the seat 30 is fixed to the seat frame 40, and a second inclined portion 35c that is continuous with a rear end of the first inclined surface 35b and extends rearward. An upper surface of the second inclined portion 35c is inclined downward at a second angle θ2 smaller than the angle of the first inclined portion 35b with respect to the horizontal plane in a state where the seat 30 is fixed to the seat frame 40.

The positioning abutment portion 35 is configured to be able to abut on the seat frame 40, specifically, the rear frame 42, disposed between the bottom plate main body portion 34 and the claw portion 35a. In other words, the positioning abutment portion 35 has an abutment portion having a vertical dimension between the bottom plate main body portion 34 and the claw portion 35a that is the same as a diameter of the rear frame 42. In front of the abutment portion, the vertical dimension between the bottom plate main body portion 34 and the claw portion 35a is smaller than the diameter of the rear frame 42. Behind the abutment portion, the vertical dimension between the bottom plate main body portion 34 and the claw portion 35a is larger than the diameter of the rear frame 42. With such a structure, the positioning abutment portion 35 prevents rearward movement with respect to the seat frame 40, and allows rotation of the seat bottom plate 33 with respect to the seat frame 40 with the abutment position with the seat frame 40 disposed between the bottom plate main body portion 34 and the claw portion 35a as a fulcrum. In the present embodiment, the second inclined portion 35c is formed behind the first inclined portion 35b, and thus, the seat 30 can be easily guided such that the rear frame 42 is located at the abutment position.

The positioning abutment portion 35 has a facing portion 35e that protrudes downward from the bottom plate main body portion 34 in a state where the seat 30 is fixed to the seat frame 40 and faces the lower surface of the seat frame 40 in a state where the positioning abutment portion 35 abuts on the seat frame 40. The facing portion 35e is constituted by the claw portion 35a. The claw portion 35a includes a plurality of ribs, but may include one rib. The claw portion 35a can be formed in another shape such that the upper surface thereof is formed only with the first inclined portion inclined downward at the first angle θ1 with respect to the horizontal plane in a state where the seat 30 is fixed to the seat frame 40.

The seat frame 40 includes a frame portion 45 having a circular outer shape that is disposed below the seat bottom plate 33, abuts on the positioning abutment portion 35, and supports the seat bottom plate 33 from below. As illustrated in FIG. 6, the seat frame 40 includes an abutted portion 46 that abuts on the positioning abutment portion 35 and a support portion 47 that supports the seat bottom plate 33 from below, and the support portion 47 is provided on both sides of the abutted portion 46 adjacent to the abutted portion 46. As illustrated in FIG. 7, the seat bottom plate 33 has a lower surface provided with a seat frame groove portion 34d recessed upward in a substantially rectangular cross section. The seat frame 40 is disposed in the seat frame groove portion 34d.

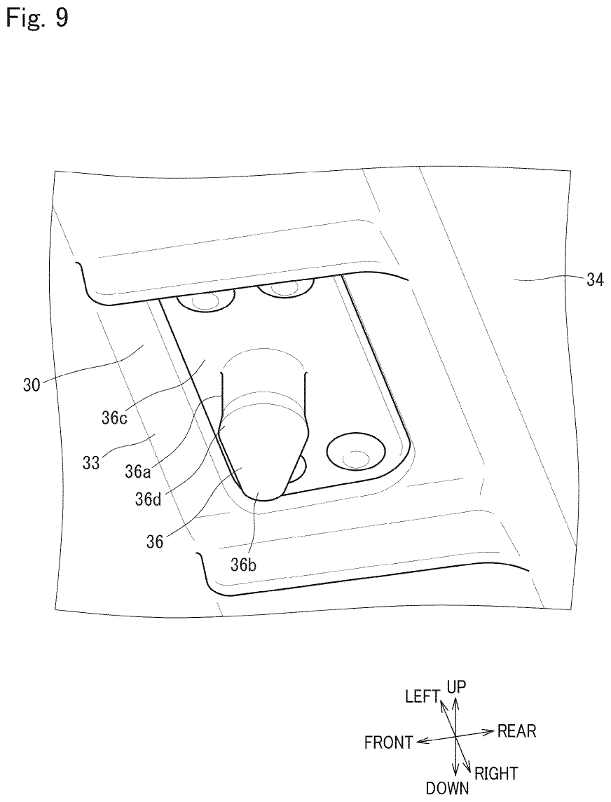

FIG. 9 is a view illustrating the engaging portion of the seat. As illustrated in FIG. 9, the engaging portion 36 has a convex portion 36a protruding downward in a substantially columnar shape from the bottom plate main body portion 34 of the seat bottom plate 33. The convex portion 36a has a pin portion 36b and a base portion 36c. A tip portion of the pin portion 36b is formed in a tapered shape, specifically, a conical shape, and a base portion of the pin portion 36b is formed in a cylindrical shape. The tip portion of the pin portion 36b has an enlarged diameter portion 36d having a diameter larger than that of the base portion on the base portion side. The enlarged diameter portion 36d does not have to be provided in the pin portion 36b.

As illustrated in FIG. 7, the seat frame 40, specifically, the front frame 41 is provided with an engaged portion 48 that is positioned by being engaged with the engaging portion 36 of the seat bottom plate 33. As illustrated in FIG. 6, a plurality of, specifically, four engaged portions 48 are provided in the longitudinal direction of the front frame 41.

As illustrated in FIG. 7, a locking bracket 49 extending rearward in a substantially horizontal direction is fixedly attached to the front frame 41. The locking bracket 49 has a circular through hole 49a, and a grommet 48d is attached to the through hole 49a. The grommet 48d is formed in a substantially cylindrical shape and has a through hole, and a peripheral edge portion of the grommet 48d covers an upper surface and a lower surface of the locking bracket 49. The grommet 48d is formed with an elastic member 48d such as rubber.

The engaged portion 48 is formed with the locking bracket 49 including the grommet 48d. The engaged portion 48 has a concave portion 48a recessed in a substantially columnar shape, and the concave portion 48a has an engagement surface portion 48b extending in a direction orthogonal to the horizontal direction on the rear side of the front frame 41 and a circular engagement hole portion 48c formed in the engagement surface portion 48b. The engaged portion 48 may be constituted by the locking bracket 49 not including the grommet 48d.

The seat bottom plate 33 has a portion located below the engaging portion 36 on the rear side of the engaging portion 36 in the bottom plate main body portion 34. In the cushion material 32, the rear portion 32a that supports the buttocks of the occupant is located below the front portion 32b that supports the thigh of the occupant, and the rear portion of the bottom plate main body portion 34 of the seat bottom plate 33 is located below the front portion.

The bottom plate main body portion 34 is arranged at substantially the same height in the vertical direction between the front portion 34a provided with the engaging portion 36 and the rear portion 34b provided with the positioning abutment portion 35, and a front-rear direction center portion 34c has a portion located below the engaging portion 36 on the rear side of the engaging portion 36.

As illustrated in FIG. 6, the seat bottom plate 33 includes a guide portion 37 that guides the seat bottom plate 33 to a seating rotation position where the engaging portion 36 is engaged with the seat frame 40 in the vehicle width direction that is an orthogonal direction orthogonal to each of the vertical direction of the seat bottom plate 33 and the front-rear direction that is a predetermined direction with respect to the seat frame 40 in a state where the positioning abutment portion 35 abuts on the seat frame 40. The guide portion 37 is located closer to the positioning abutment portion 35 than the engaging portion 36 in the front-rear direction which is a predetermined direction.

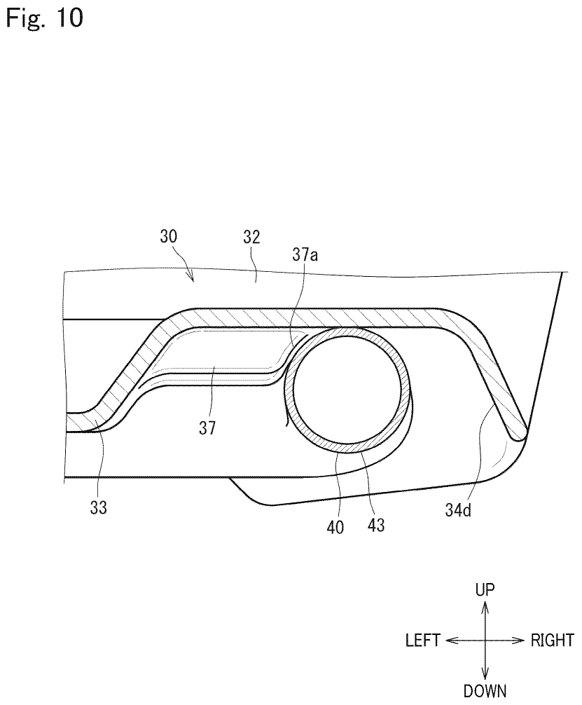

FIG. 10 is a view illustrating the guide portion of the seat. FIG. 10 is a cross-sectional view of the vicinity of the connection frame 43 on the right side of the vehicle body taken along the vehicle width direction. The guide portions 37 are provided on both sides of the seat bottom plate 33 in the vehicle width direction. As illustrated in FIG. 10, the guide portion 37 is formed with a rib protruding downward from the seat bottom plate 33, and is provided outside in the vehicle width direction on the lower surface of the seat bottom plate 33.

The guide portion 37 is provided in the seat frame groove portion 34d, and includes an inclined portion 37a that is inclined upward from the inside in the vehicle width direction toward the outside in the vehicle width direction. At least one guide portion 37 is provided on each side in the vehicle width direction of the seat bottom plate 33. A guide portion that guides the seat bottom plate 33 may be provided on the front side of the seat bottom plate 33. The seat 30 can be positioned in the front-rear direction by being guided to the seat frame 40 by the guide portion. It is preferable that positioning in the left-right direction and the front is performed before the engaging portion 36 is fitted into the engaged portion 48. By appropriately setting the vertical dimension of the guide portion and the vertical dimension of the engaging portion, the guide portion is guided to the seat frame 40 before contact between the engaging portion 36 and the engaged portion 48.

When the seat 30 is attached to the seat frame 40, as indicated by a two-dot chain line in FIG. 7, in a state where the front side of the seat 30 is lifted upward from the rear side of the seat 30, the positioning abutment portion 35 of the seat 30 is made to abut on the rear frame 42 of the seat frame 40 to prevent movement of the seat 30 rearward with respect to the seat frame 40.

Then, the front side of the seat 30 is rotated and moved downward with the abutment position with the seat frame 40 as a fulcrum, and the seat 30 is guided in the left-right direction by the guide portion 37, and the like. This prevents positional displacement of the seat 30 in the left-right direction. Preferably, the guide portion is provided on the front side of the seat bottom plate 33, and positional displacement of the seat 30 in the front-rear direction is also prevented.

Further, the front side of the seat 30 is moved downward, and the engaging portion 36 is engaged with the engaged portion 48 of the seat frame 40 at a predetermined seating rotation position with respect to the seat frame 40 while the positioning abutment portion 35 abuts on the seat frame 40. At the seating rotation position, the seat bottom plate 33 is locked in contact with the grommet 48d. When the seat 30 is attached to the seat frame 40, the engaging portion 36 is engaged with the seat frame 40 via an elastic member 48d that is an elastically deformable buffer member.

The guide portion 37 is located closer to the positioning abutment portion 35 than the engaging portion 36 in the front-rear direction, and thus, the guide portion 37 can guide the seat bottom plate 33 in the vehicle width direction with respect to the seat frame 40 before the seat bottom plate 33 is positioned with respect to the seat frame 40 by the engaging portion 36.

When the seat 30 is removed from the seat frame 40, the front side of the seat 30 is lifted to disengage the engaging portion 36 from the engaged portion 48 of the seat frame 40, and then the front side of the seat 30 is moved forward to release the abutment state of the seat 30 with respect to the seat frame 40, and the rear side of the seat 30 is disengaged from the rear frame 42 of the seat frame 40.

In the engaging portion 36 provided on the front side of the seat 30, the enlarged diameter portion 36d is formed on the base portion side of the tip portion of the pin portion 36b, and thus, disengagement from the engaged portion 48 of the seat frame 40 due to vibration, or the like, is suppressed. However, by applying a predetermined lifting force to the front side of the seat 30, the seat 30 can be disengaged from the engaged portion 48 of the seat frame 40 and removed from the seat frame 40.

In the utility vehicle 1, when the engaging portion 36 of the seat 30 is engaged with the engaged portion 48 of the seat frame 40, the front frame 41 comes into contact with the bottom surface of the seat frame groove portion 34d. Alternatively, the front frame 41 does not have to come into contact with the bottom surface of the seat frame groove portion 34d. The engaging portion 36 is formed by a columnar convex portion 36a, and the engaged portion 48 is formed by a columnar concave portion 48a. However, the engaging portion 36 may be formed by a columnar concave portion, and the engaged portion 48 may be formed by a columnar convex portion.

As illustrated in FIG. 5, the seat bottom plate 33 has a bottom plate cutout portion 33a through which a portion of the seat belt 61 is inserted, and the cushion material 32 has a cushion cutout portion 32c through which a portion of the seat belt 61 is inserted. The cushion cutout portion 32c is formed smaller than the bottom plate cutout portion 33a so as to suppress contact of the seat belt 61 with the seat bottom plate 33.

As illustrated in FIG. 3, the seat 30 is a bench seat for three people, and the seat 30 is equipped with three seat belt devices 60. The seat belt device 60 is, for example, a four-point seat belt device. The seat belt device 60 includes a seat belt 61 that restrains an occupant seated on the seat 30, and the seat belt 61 includes left and right waist belts 61a fixed to a belt anchor 62.

One end portions of the waist belts 61a on the outer side in the vehicle width direction for the left and right occupants are attached to the belt anchor fixed to the support frame 16 disposed below the seat 30 through the outer side in the vehicle width direction of the seat 30. One end portions of the waist belts 61a on the inner side in the vehicle width direction for the left and right occupants and one end portions of the waist belt 61a on both sides in the vehicle width direction for the center occupant are attached to the belt anchor 62 fixedly attached to the seat frame 40 disposed below the seat 30 through the cushion cutout portion 32c of the seat 30. As illustrated in FIG. 6, two belt anchors 62 are attached to the rear frame 42.

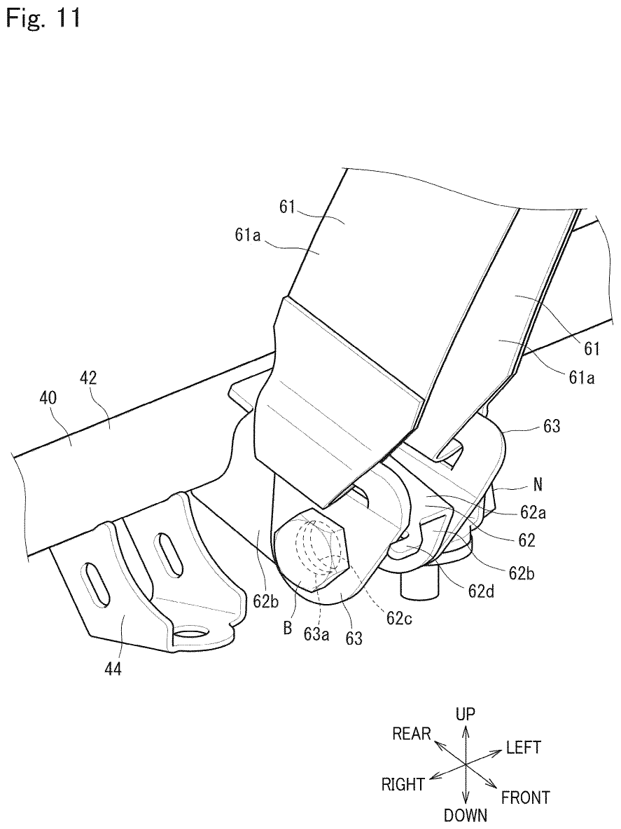

FIG. 11 is a view illustrating the belt anchor. As illustrated in FIG. 11, the belt anchor 62 includes an upper surface portion 62a and side surface portions 62b on both sides extending downward from both sides of the upper surface portion 62a in the vehicle width direction. The upper surface portion 62a is attached to the front side of the rear frame 42 and is inclined downward toward the front side. The side surface portions 62b on both sides are arranged substantially in parallel, and bolt insertion holes 62c are formed in the side surface portions 62b on the both sides, respectively.

An attachment fitting 63 is attached to the waist belt 61a fixed to the belt anchor 62, and a bolt insertion hole 63a is formed in the attachment fitting 63. A fastening bolt B is screwed into a nut N through the bolt insertion holes 62a of the side surface portions 62b on both sides and the bolt insertion hole 66a of the attachment fitting 66 in a state where the attachment fitting 63 of the waist belt 61a is disposed on each of the side surface portions 62b on both sides of the belt anchor 62, whereby the waist belt 61a is fixed to the belt anchor 62.

An upper surface portion 62a of the belt anchor 62 is provided with stoppers 62d protruding outward from the side surface portions 62b on both sides. One stopper 62d is disposed in front of an attachment fitting 66 and the other stopper is disposed behind the attachment fitting 66 so as to restrict rotation of the attachment fitting 66 when the fastening bolt B and the nut N are screwed.

The belt anchor 62 to which the waist belt 61a on the right side of the left occupant and the waist belt 61a on the left side of the center occupant are attached, and the belt anchor 62 to which the waist belt 61a on the left side of the right occupant and the waist belt 61a on the right side of the center occupant are attached are fixed to the rear frame 42.

As illustrated in FIG. 5, the belt anchor 62 is disposed below the seat 30 in top view, and the seat 30 is formed with a seat cutout portion 30a recessed in a rectangular shape on the front side on the rear end surface of the seat 30 corresponding to the belt anchor 62. A portion of the seat belt 61 is inserted into the seat cutout portion 30a. As illustrated in FIG. 6, the positioning abutment portion 35 is provided in the vicinity of the bottom plate cutout portion 33a.

In the utility vehicle 1, the seat 30 is a seat for three occupants. However, even in a case where a seat for two occupants that is disposed behind the seat for three occupants and has a large foot space is used, the seat belt can be disposed at an appropriate position by providing the seat cutout portion 30a.

As illustrated in FIG. 3, the seat back 31 separate from the seat 30 is disposed behind the seat 30. The seat back 31 is formed longer in the vehicle width direction than in the vertical direction, and is attached to the seat back frame 20 illustrated in FIG. 2. The seat back frame 20 includes an upper seat back frame 21 attached to the fourth cross member 10d and extending in the vehicle width direction, and lower seat back frames 22 attached to both sides of the second support cross frame 18 and extending in the vehicle width direction.

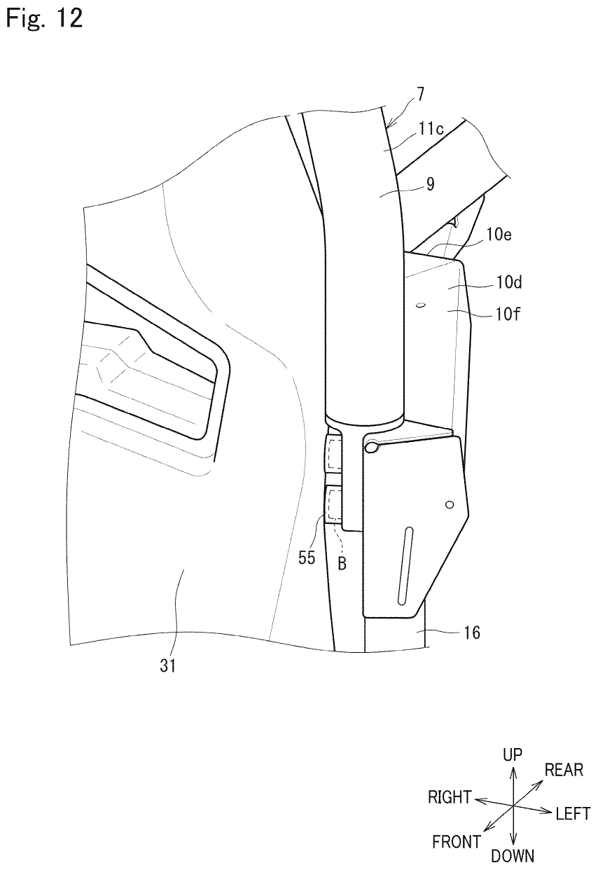

FIG. 12 is a perspective view illustrating an abutment portion between the ROPS frame and the seat back of the seat. As illustrated in FIG. 12, a cover member 55 is attached so as to cover the fastening bolt B for coupling the lower end portion of the third vertical frame 11c to the upper end portion of the support frame 16. The cover member 55 is formed with an elastic member 55 such as rubber. An outer portion of the seat back 31 in the vehicle width direction indirectly abuts on the side frame 9 via the elastic member 55.

The fastening bolt B is disposed from the inside in the vehicle width direction toward the outside in the vehicle width direction and from the front side toward the rear side, and is disposed such that a central axis is inclined with respect to the front-rear direction and the vehicle width direction. The elastic member 55 abuts on the seat back 31 in a direction inclined with respect to the front-rear direction and the vehicle width direction. The outer portion of the seat back 31 in the vehicle width direction may directly abut on the vertical frame 11c of the side frame 9 without interposing an elastic member therebetween.

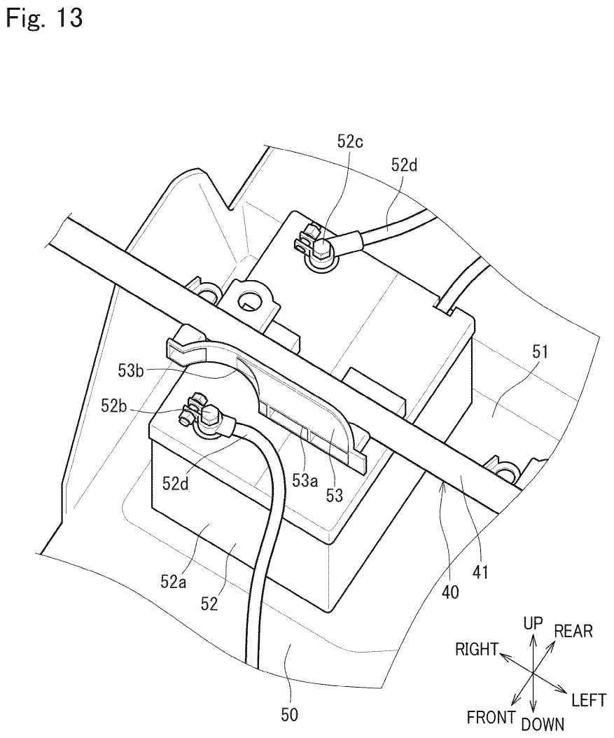

FIG. 13 is a perspective view of the vicinity of a battery including an electric shock preventing member. As illustrated in FIG. 13, a battery 52 disposed in the housing space 51 on the left side of the vehicle body includes a positive terminal 52b and a negative terminal 52c on the upper surface of a battery case 52a. A connection cable 52d is connected to each of the positive terminal 52b and the negative terminal 52c. The negative terminal 52c is located below and on the rear side of the front frame 41, and the positive terminal 52b is located below and on the front side of the front frame 41.

In order to prevent a short circuit of the battery 52 when the connection cable 52d is attached to and detached from the positive terminal 52b using a metal tool, a resin electric shock preventing member 53 is attached to the front frame 41. The electric shock preventing member 53 has a concave portion 53b recessed in a substantially arc shape on the rear side corresponding to the positive terminal 52b on the front surface 53a, and covers the front side of the front frame 41.

The electric shock preventing member 53 can prevent the operator from getting electric shock when the operator attaches and detaches the connection cable 52d to and from the positive terminal 52b using a metal tool. In the housing space 51, other articles such as luggage of the occupant may be disposed, and maintenance parts such as a battery, a relay, or a fuse may be disposed.

In the present embodiment, when the seat 30 is attached to the seat frame 40, the engaged portion 48 which is an engaged portion is formed behind the front portion of the seat frame 40. Accordingly, when the seat is attached to the seat frame, it is possible to suppress increase in size of the seat frame 40 as compared with a case where the engaging portion is formed in front of the front portion of the seat frame.

The positioning abutment portion 35 and the engaging portion 36 are provided on the lower surface of the bottom plate main body portion 34. Accordingly, when the seat 30 is attached to the seat frame 40, it is possible to prevent the positioning abutment portion 35 and the engaging portion 36 from being exposed.

Further, in the seat frame 40, when the seat frame abuts on the positioning abutment portion 35 of the seat bottom plate 33, two upper and lower points of the circular frame portion 45 are positioned by being in contact with the seat bottom plate 33, but the positioning abutment portion 35 may be formed in another shape such as an arc shape so as to be in surface contact with the circular frame portion 45, and may be positioned by being in contact with only the claw portion 35a.

In addition, although the positioning abutment portion 35 is provided on the rear side of the seat bottom plate 33 and the engaging portion 36 is provided on the front side of the seat bottom plate 33, the positioning abutment portion may be provided on the front side of the seat bottom plate 33 and the engaging portion may be provided on the rear side of the seat bottom plate 33, and the seat 30 may be attached to the seat frame 40 while preventing forward movement as one predetermined direction perpendicular to the vertical direction with respect to the seat frame. Alternatively, the positioning abutment portion may be provided on one side in the vehicle width direction of the seat bottom plate 33, and the engaging portion may be provided on the other side in the vehicle width direction of the seat bottom plate 33, so that the seat 30 may be attached to the seat frame 40 while preventing movement in one direction in the vehicle width direction as one predetermined direction perpendicular to the vertical direction with respect to the seat frame.

In the present embodiment, the positioning abutment portion 35 is provided on the seat bottom plate 33, the abutted portion 46 is provided on the seat frame 40, and the seat 30 is made to abut on the seat frame 40. However, the positioning abutment portion may be provided on the seat frame 40, and the abutted portion may be provided on the seat bottom plate 33. In addition, although a plurality of positioning abutment portions 35 and a plurality of engaging portions 36 are provided in the vehicle width direction orthogonal to the vertical direction and the front-rear direction, respectively, at least one of the positioning abutment portions 35 or the engaging portions 36 may be arranged in the vehicle width direction. It is preferable that at least two or more positioning abutment portions 35 are disposed in the vehicle width direction.

As described above, the utility vehicle 1 according to the present embodiment includes the seat 30 on which the occupant is seated, the seat 30 including the cushion material 32 and the seat bottom plate 33 to which the cushion material 32 is attached, and the seat frame 40 to which the seat bottom plate 33 is attached. The seat bottom plate 33 includes the positioning abutment portion 35 that abuts on the seat frame 40 to prevent movement in one predetermined direction perpendicular to the vertical direction with respect to the seat frame 40 and to allow rotation with an abutment position with the seat frame 40 as a fulcrum, and the engaging portion 36 that is engaged with the seat frame 40 in the vertical direction at a predetermined seating rotation position with respect to the seat frame 40 while the positioning abutment portion 35 abuts on the seat frame 40.

As a result, the positioning abutment portion 35 of the seat bottom plate 33 abuts on the seat frame 40, so that the seat 30 is prevented from moving in one predetermined direction perpendicular to the vertical direction with respect to the seat frame 40. In a state where the positioning abutment portion 35 of the seat bottom plate 33 abuts on the seat frame 40, the seat 30 is rotated so as to approach the seat frame 40. The engaging portion 36 of the seat bottom plate 33 is vertically engaged with the seat frame 40 at the seating rotation position. As a result, the seat 30 can be prevented from being displaced with respect to the seat frame 40, and the seat 30 can be easily engaged with the seat frame 40. By suppressing positional displacement of the seat 30 with respect to the seat frame 40 to facilitate engagement of the seat 30 with the seat frame 40, it is possible to simplify a fixing structure for fixing the seat 30 to the seat frame 40.

The seat bottom plate 33 includes the bottom plate main body portion 34 formed in a plate shape, and the positioning abutment portion 35 and the engaging portion 36 can be integrally molded with the bottom plate main body portion 34. As a result, the positioning abutment portion 35 and the engaging portion 36 can be formed together with molding of the bottom plate main body portion 34, and the number of parts can be reduced as compared with the case where the positioning abutment portion and the engaging portion are formed as members separate from the bottom plate main body portion.

The seat bottom plate 33 may include the guide portion 37 that guides the seat bottom plate 33 to a position where the engaging portion 36 is engaged with the seat frame 40 in the vertical direction of the seat bottom plate 33 and an orthogonal direction orthogonal to a predetermined direction with respect to the seat frame 40 in a state where the positioning abutment portion 35 abuts on the seat frame 40. As a result, the seat bottom plate 33 rotated with the abutment position as a fulcrum can be positioned in the predetermined direction and the orthogonal direction, and the seat 30 can be easily engaged with the seat frame 40.

The guide portion 37 can be located closer to the positioning abutment portion 35 than the engaging portion 36 in the predetermined direction. Accordingly, before the seat bottom plate 33 is positioned with respect to the seat frame 40 by the engaging portion 36, the seat bottom plate 33 can be guided with respect to the seat frame 40 by the guide portion 37.

The seat bottom plate 33 may include the bottom plate main body portion 34 formed in a plate shape, the positioning abutment portion 35 may protrude downward from the bottom plate main body portion 34, and the seat frame 40 may include the frame portion 45 having a circular outer shape that abuts on the positioning abutment portion 35 and supports the seat bottom plate 33 from below. With such a configuration, the seat frame 40 abuts on the positioning abutment portion 35 and supports the seat bottom plate 33 from below, so that it is possible to suppress increase in size of the seat frame 40 compared to a case where a portion which abuts on the positioning abutment portion 35 and a portion which supports the seat 30 are separately provided. The frame portion 45 has a circular outer shape, and thus, the seat bottom plate 33 can easily rotate with respect to the seat frame 40 in a state where the positioning abutment portion 35 abuts on the frame portion 45.

The seat bottom plate 33 may have the bottom plate main body portion 34 formed in a plate shape, and the positioning abutment portion 35 may have a facing portion 35e that protrudes downward from the bottom plate main body portion 34 and faces the lower surface of the seat frame 40 in a state of abutting on the seat frame 40. With such a configuration, in a case where a load in the upward direction is applied to the seat 30 in a state where the seat bottom plate 33 abuts on the seat frame 40 by the positioning abutment portion 35, it is possible to prevent the seat 30 from being unintentionally moved upward with respect to the seat frame 40.

The seat bottom plate 33 may have the bottom plate main body portion 34 formed in a plate shape, the positioning abutment portion 35 may protrude downward from the bottom plate main body portion 34, and the seat frame 40 may have the abutted portion 46 abutting on the positioning abutment portion 35 and the support portion 47 adjacent to the abutted portion 46 and supporting the seat bottom plate 33 from below. Accordingly, the support portion 47 is located adjacent to the abutted portion 46 of the seat frame 40, so that it is possible to suppress increase in size of the seat frame 40.

The engaging portion 36 may be engaged with the seat frame 40 via an elastically deformable buffer member 48d. Accordingly, the engaging portion 36 of the seat bottom plate 33 is engaged with the seat frame 40 via the buffer member 48d, and thus, even in a case where an assembly error and a shape error occur between the seat bottom plate 33 and the seat frame 40, the buffer member 48d can absorb the assembly error and the shape error.

The seat frame 40 has the engaged portion 48 positioned by being engaged with the engaging portion 36, the engaging portion 36 may be formed by one of the columnar convex portion 36a and the concave portion 48a, and the engaged portion 48 may be formed by the other of the columnar convex portion 36a and the concave portion 48a. As a result, the engaging portion 36 and the engaged portion 48 are formed in a columnar uneven shape, so that it is possible to easily absorb an assembly error and a shape error with respect to the predetermined direction and the orthogonal direction as compared with the case of being formed in a non-columnar shape.

The seat bottom plate 33 may have the bottom plate main body portion 34 formed in a plate shape, the engaging portion 36 may be provided on the front side of the bottom plate main body portion 34, and the seat bottom plate 33 may have a portion located below the engaging portion 36 on the rear side of the engaging portion 36. As a result, the rear side of the seat 30, which is a region where the buttocks of the occupant are located, can be inclined downward as compared with the front side of the seat 30 where the thigh of the occupant is located, so that the ride comfort of the occupant can be improved.

The positioning abutment portion 35 may be provided on the rear side of the seat bottom plate 33, and the engaging portion 36 may be provided on the front side of the seat bottom plate 33. With such a configuration, in a case where a length of the seat 30 in the vehicle width direction is larger than a length in the longitudinal direction, in a state where the positioning abutment portion 35 of the seat bottom plate 33 abuts on the seat frame 40, it is possible to suppress a rotation angle of the seat bottom plate 33 in a rotation direction with respect to the seat frame 40 in order to attach and detach the seat bottom plate 33 to and from the seat frame 40, and it is possible to suppress interference with other components of the utility vehicle 1 when the seat 30 is attached and detached.

The utility vehicle 1 includes the seat back 31 separate from the seat 30, and the seat back 31 can be disposed apart from the seat 30 in the vertical direction. As a result, interference between the seat 30 and the seat back 31 can be suppressed when the seat 30 is attached and detached.

A plurality of at least one of the positioning abutment portion 35 and the engaging portion 36 may be arranged in an orthogonal direction orthogonal to the vertical direction and the predetermined direction. Accordingly, when the seat 30 is attached to the seat frame 40, it is possible to prevent the seat 30 from rotating around the vertical axis with respect to the seat frame 40.

The utility vehicle 1 includes the vehicle body frame 8 to which the seat frame 40 is attached. The seat frame 40 is detachably attached to the vehicle body frame 8. The seat frame 40 includes the front frame 41 that extends in the vehicle width direction on the front side of the seat bottom plate 33 and supports the front side of the seat bottom plate 33 from below, the rear frame 42 that extends in the vehicle width direction on the rear side of the seat bottom plate 33 and supports the rear side of the seat bottom plate 33 from below, and the connection frame 43 that connects the front frame 41 and the rear frame 42. As a result, the seat frame 40 is unitized, the positioning abutment portion 35 is made to abut on the rear frame 42 of the unitized seat frame 40, the engaging portion 36 is aligned with the unitized front frame 41, and the seat 30 is attached to the seat frame 40, whereby the seat 30 can be attached to the seat frame 40 while influence of an assembly error between the seat frame 40 and the vehicle body frame 8 is suppressed.

In the utility vehicle 1, the housing space 51 in which articles are housed can be provided below the seat 30. Accordingly, articles such as maintenance parts can be housed in the housing space 51 below the seat 30, and the articles are accessible by detaching the seat 30 from the seat frame 40.

The seat bottom plate 33 has the bottom plate cutout portion 33a through which a portion of the seat belt 61 is inserted, and the positioning abutment portion 35 can be provided in the vicinity of the bottom plate cutout portion 33a. As a result, the seat bottom plate 33 has the bottom plate cutout portion 33a through which a portion of the seat belt 61 is inserted, so that a degree of freedom in arrangement of the seat 30 on which the occupant to be restrained by the seat belt 61 is seated can be improved. The positioning abutment portion 35 is provided in the vicinity of the bottom plate cutout portion 33a, deformation of the seat 30 in the vicinity of the bottom plate cutout portion 33a can be suppressed by the positioning abutment portion 35.

The seat bottom plate 33 has the bottom plate cutout portion 33a through which a portion of the seat belt 61 is inserted, the cushion material 32 has the cushion cutout portion 32c through which a portion of the seat belt 61 is inserted, and the cushion cutout portion 32c can be formed smaller than the bottom plate cutout portion 33a. As a result, the bottom plate cutout portion 33a of the seat bottom plate 33 can be covered with the cushion material 32, and the seat belt 61 can be prevented from coming into contact with the seat bottom plate 33.

The utility vehicle 1 may include the ROPS frame 7 that defines an upper portion of the riding space 4, and the seat back 31 that is separate from the seat 30. The ROPS frame 7 includes a pair of left and right vertical frames 11c extending in the vertical direction behind the riding space 4 and the cross member 10d extending in the vehicle width direction between the pair of left and right vertical frames 11c, and both sides of the cross member 10d in the vehicle width direction can extend outward in the vehicle width direction toward the front side so that the dimension of the rear side of the riding space 4 in the vehicle width direction decreases toward the rear side. As a result, as the seat 30 disposed on the rear side of the riding space 4, a seat having a large space on the front side of the seat and a small size in the vehicle width direction and a seat having a small space on the front side of the seat and a large size in the vehicle width direction can be used, and seats corresponding to the number of occupants can be disposed.

Further, the utility vehicle 1 according to the present embodiment includes the seat 30 on which an occupant is seated, the seat frame 40 disposed below the seat 30, the seat belt 61 capable of restraining the occupant seated on the seat 30, and the belt anchor 62 to which one end portion of the seat belt 61 is fixed. The seat 30 has the seat cutout portion 30a through which a portion of the seat belt 61 is inserted, and the belt anchor 62 is fixed to the seat frame 40 below the seat cutout portion 30a.

Accordingly, the belt anchor 62 is fixed to the seat frame 40 below the seat cutout portion 30a, and thus, the seat 30 can be provided with the seat cutout portion 30a, and the belt anchor 62 can be disposed below the buttocks of the occupant. Even if the seat is located relatively forward or rearward, the seat belt 61 can easily keep the occupant restrained.

The utility vehicle 1 according to the present embodiment includes the ROPS frame 7 that defines an upper portion of the riding space 4, the seat 30 disposed in the riding space 4, and the seat back 31 disposed in the riding space 4. The ROPS frame 7 has a pair of left and right vertical frames 11c extending in the vertical direction on the outer side in the vehicle width direction, and the outer portion in the vehicle width direction of the seat back 31 directly or indirectly abuts on the vertical frames 11c.

Accordingly, in a case where a load acts on the seat back 31 from the occupant, the load can be supported by the vertical frame 11c. Even in a case where behavior of the vehicle suddenly changes during traveling, deformation of the seat back 31 can be suppressed, and the support state of the occupant can be maintained. The deformation of the seat back 31 can be suppressed without undesirably increasing rigidity of the seat back 31.

The seat 30 of the utility vehicle 1 according to the present embodiment is exemplified as a two-row seat, but the seat 30 can be also applied to a single-row seat. Further, a structure of the rear seat 30 may be adopted as the structure of the front seat 13. The structure of the seat 30 may be applied as a bench seat serving as one seat for two or three occupants sitting side by side, or may be applied to separate seats for each occupant.

The present disclosure is not limited to the exemplified embodiments, and various improvements and design changes can be made without departing from the gist of the present disclosure.

### Supplementary Note 1

A utility vehicle including:
a seat on which an occupant is seated, the seat including a cushion material and a seat bottom plate to which the cushion material is attached; and
a seat frame to which the seat bottom plate is attached,
in which the seat bottom plate includes:
   a positioning abutment portion that abuts on the seat frame to prevent movement in one predetermined direction perpendicular to a vertical direction with respect to the seat frame and to allow rotation with an abutment position with the seat frame as a fulcrum; and
   an engaging portion that is engaged with the seat frame in the vertical direction at a predetermined seating rotation position with respect to the seat frame while the positioning abutment portion abuts on the seat frame.

### Supplementary Note 2

The utility vehicle according to Supplementary Note 1, in which
the seat bottom plate includes a bottom plate main body portion formed in a plate shape, and
the positioning abutment portion and the engaging portion are integrally molded with the bottom plate main body portion.

### Supplementary Note 3

The utility vehicle according to Supplementary Note 1 or 2, in which the seat bottom plate includes a guide portion that guides the seat bottom plate to a position where the engaging portion is engaged with the seat frame in a vertical direction of the seat bottom plate with respect to the seat frame and in an orthogonal direction orthogonal to the predetermined direction in a state where the positioning abutment portion abuts on the seat frame.

### Supplementary Note 4

The utility vehicle according to Supplementary Note 3, in which the guide portion is located closer to the positioning abutment portion than the engaging portion in the predetermined direction.

### Supplementary Note 5

The utility vehicle according to any one of Supplementary Notes 1 to 4, in which
the seat bottom plate includes a bottom plate main body portion formed in a plate shape,
the positioning abutment portion protrudes downward from the bottom plate main body portion, and
the seat frame includes a frame portion having a circular outer shape that abuts on the positioning abutment portion and supports the seat bottom plate from below.

### Supplementary Note 6

The utility vehicle according to any one of Supplementary Notes 1 to 5, in which
the seat bottom plate includes a bottom plate main body portion formed in a plate shape, and
the positioning abutment portion includes a facing portion that protrudes downward from the bottom plate main body portion and faces a lower surface of the seat frame in a state where the positioning abutment portion abuts on the seat frame.

### Supplementary Note 7

The utility vehicle according to any one of Supplementary Notes 1 to 6, in which
the seat bottom plate includes a bottom plate main body portion formed in a plate shape,
the positioning abutment portion protrudes downward from the bottom plate main body portion, and
the seat frame includes an abutted portion abutting on the positioning abutment portion and a support portion adjacent to the abutted portion and supporting the seat bottom plate from below.

### Supplementary Note 8

The utility vehicle according to any one of Supplementary Notes 1 to 7, in which the engaging portion is engaged with the seat frame via an elastically deformable buffer member.

### Supplementary Note 9

The utility vehicle according to any one of Supplementary Notes 1 to 8, in which
the seat frame includes an engaged portion positioned by being engaged with the engaging portion,
the engaging portion is formed by one of a columnar convex portion and a columnar concave portion, and
the engaged portion is formed by the other of the columnar convex portion and the columnar concave portion.

### Supplementary Note 10

The utility vehicle according to any one of Supplementary Notes 1 to 9, in which
the seat bottom plate includes a bottom plate main body portion formed in a plate shape,
the engaging portion is provided on a front side of the bottom plate main body portion, and
the seat bottom plate includes a portion located below the engaging portion on a rear side of the engaging portion.

### Supplementary Note 11

The utility vehicle according to any one of Supplementary Notes 1 to 10, in which
the positioning abutment portion is provided on a rear side of the seat bottom plate, and
the engaging portion is provided on a front side of the seat bottom plate.

### Supplementary Note 12

The utility vehicle according to any one of Supplementary Notes 1 to 11, further including a seat back provided separately from the seat,
in which the seat back is disposed apart from the seat in a vertical direction.

### Supplementary Note 13

The utility vehicle according to any one of Supplementary Notes 1 to 12, in which a plurality of at least one of the positioning abutment portion and the engaging portion is disposed in an orthogonal direction orthogonal to a vertical direction and the predetermined direction.

### Supplementary Note 14

The utility vehicle according to any one of Supplementary Notes 1 to 13, further including a vehicle body frame to which the seat frame is attached, in which
the seat frame is detachably attached to the vehicle body frame, and
the seat frame includes: a front frame that extends in a vehicle width direction on a front side of the seat bottom plate and supports a front side of the seat bottom plate from below; a rear frame that extends in the vehicle width direction on a rear side of the seat bottom plate and supports a rear side of the seat bottom plate from below; and a connection frame that connects the front frame and the rear frame.

### Supplementary Note 15

The utility vehicle according to any one of Supplementary Notes 1 to 14, in which a housing space in which articles are housed is provided below the seat.

### Supplementary Note 16

The utility vehicle according to any one of Supplementary Notes 1 to 15, in which
the seat bottom plate includes a bottom plate cutout portion through which a portion of a seat belt is inserted, and
the positioning abutment portion is provided near the bottom plate cutout portion.

### Supplementary Note 17

The utility vehicle according to any one of Supplementary Notes 1 to 16, in which
the seat bottom plate includes a bottom plate cutout portion through which a portion of a seat belt is inserted,
the cushion material includes a cushion cutout portion through which a portion of a seat belt is inserted, and
the cushion cutout portion is smaller than the bottom plate cutout portion.

### Supplementary Note 18

The utility vehicle according to any one of Supplementary Notes 1 to 17, further including:
a ROPS frame surrounding a riding space; and
a seat back separate from the seat, in which
the ROPS frame includes a pair of left and right vertical frames extending in a vertical direction behind the riding space, and a cross member extending in a vehicle width direction between the pair of left and right vertical frames, and
both sides in the vehicle width direction of the cross member extend outward in the vehicle width direction toward a front side such that a dimension of a rear side of the riding space in the vehicle width direction decreases toward a rear side.

### Supplementary Note 19

A utility vehicle including:
a seat on which an occupant is seated;
a seat frame disposed below the seat;
a seat belt capable of restraining the occupant seated on the seat; and
a belt anchor to which one end portion of the seat belt is fixed, in which
the seat includes a seat cutout portion through which a portion of the seat belt is inserted, and
the belt anchor is fixed to the seat frame below the seat cutout portion.

### Supplementary Note 20

A utility vehicle including:
a ROPS frame that defines an upper portion of a riding space;
a seat disposed in the riding space; and
a seat back disposed in the riding space, in which
the ROPS frame includes a pair of left and right vertical frames extending in a vertical direction on an outer side in a vehicle width direction, and
an outer portion of the seat back in the vehicle width direction directly or indirectly abuts on the vertical frames.

What is claimed is:

1. A utility vehicle comprising:
a seat on which an occupant is seated, the seat including a cushion material and a seat bottom plate to which the cushion material is attached; and
a seat frame to which the seat bottom plate is attached,
wherein the seat bottom plate includes:
a positioning abutment portion that abuts on the seat frame to prevent movement in one predetermined direction perpendicular to a vertical direction with respect to the seat frame and to allow rotation with an abutment position with the seat frame as a fulcrum; and
an engaging portion that is engaged with the seat frame in the vertical direction at a predetermined seating rotation position with respect to the seat frame while the positioning abutment portion abuts on the seat frame.

2. The utility vehicle according to claim 1, wherein
the seat bottom plate includes a bottom plate main body portion formed in a plate shape, and
the positioning abutment portion and the engaging portion are integrally molded with the bottom plate main body portion.

3. The utility vehicle according to claim 1, wherein the seat bottom plate includes a guide portion that guides the seat bottom plate to a position where the engaging portion is engaged with the seat frame in a vertical direction of the seat bottom plate with respect to the seat frame and in an orthogonal direction orthogonal to the predetermined direction in a state where the positioning abutment portion abuts on the seat frame.

4. The utility vehicle according to claim 3, wherein the guide portion is located closer to the positioning abutment portion than the engaging portion in the predetermined direction.

5. The utility vehicle according to claim 1, wherein
the seat bottom plate includes a bottom plate main body portion formed in a plate shape,
the positioning abutment portion protrudes downward from the bottom plate main body portion, and
the seat frame includes a frame portion having a circular outer shape that abuts on the positioning abutment portion and supports the seat bottom plate from below.

6. The utility vehicle according to claim 1, wherein
the seat bottom plate includes a bottom plate main body portion formed in a plate shape, and
the positioning abutment portion includes a facing portion that protrudes downward from the bottom plate main body portion and faces a lower surface of the seat frame in a state where the positioning abutment portion abuts on the seat frame.

7. The utility vehicle according to claim 1, wherein
the seat bottom plate includes a bottom plate main body portion formed in a plate shape,
the positioning abutment portion protrudes downward from the bottom plate main body portion, and
the seat frame includes an abutted portion abutting on the positioning abutment portion and a support portion adjacent to the abutted portion and supporting the seat bottom plate from below.

8. The utility vehicle according to claim 1, wherein the engaging portion is engaged with the seat frame via an elastically deformable buffer member.

9. The utility vehicle according to claim 1, wherein
the seat frame includes an engaged portion positioned by being engaged with the engaging portion,
the engaging portion is formed by one of a columnar convex portion and a columnar concave portion, and
the engaged portion is formed by the other of the columnar convex portion and the columnar concave portion.

10. The utility vehicle according to claim 1, wherein the seat bottom plate includes a bottom plate main body portion formed in a plate shape, the engaging portion is provided on a front side of the bottom plate main body portion, and the seat bottom plate includes a portion located below the engaging portion on a rear side of the engaging portion.

11. The utility vehicle according to claim 1, wherein
the positioning abutment portion is provided on a rear side of the seat bottom plate, and
the engaging portion is provided on a front side of the seat bottom plate.

12. The utility vehicle according to claim 1, further comprising a seat back provided separately from the seat,
wherein the seat back is disposed apart from the seat in a vertical direction.

13. The utility vehicle according to claim 1, wherein a plurality of at least one of the positioning abutment portion and the engaging portion is disposed in an orthogonal direction orthogonal to a vertical direction and the predetermined direction.

14. The utility vehicle according to claim 1, further comprising a vehicle body frame to which the seat frame is attached, wherein
the seat frame is detachably attached to the vehicle body frame, and
the seat frame includes: a front frame that extends in a vehicle width direction on a front side of the seat bottom plate and supports a front side of the seat bottom plate from below; a rear frame that extends in the vehicle width direction on a rear side of the seat bottom plate and supports a rear side of the seat bottom plate from below; and a connection frame that connects the front frame and the rear frame.

15. The utility vehicle according to claim 1, wherein a housing space in which articles are housed is provided below the seat.

16. The utility vehicle according to claim 1, wherein
the seat bottom plate includes a bottom plate cutout portion through which a portion of a seat belt is inserted, and
the positioning abutment portion is provided near the bottom plate cutout portion.

17. The utility vehicle according to claim 1, wherein
the seat bottom plate includes a bottom plate cutout portion through which a portion of a seat belt is inserted,
the cushion material includes a cushion cutout portion through which a portion of a seat belt is inserted, and
the cushion cutout portion is smaller than the bottom plate cutout portion.

18. The utility vehicle according to claim 1, further comprising:
a ROPS frame surrounding a riding space; and
a seat back separate from the seat,
wherein the ROPS frame includes a pair of left and right vertical frames extending in a vertical direction behind the riding space, and a cross member extending in a vehicle width direction between the pair of left and right vertical frames, and
both sides in the vehicle width direction of the cross member extend outward in the vehicle width direction toward a front side such that a dimension of a rear side of the riding space in the vehicle width direction decreases toward a rear side.

19. A utility vehicle comprising:
a seat on which an occupant is seated;
a seat frame disposed below the seat;
a seat belt capable of restraining the occupant seated on the seat; and
a belt anchor to which one end portion of the seat belt is fixed,
wherein the seat includes a seat cutout portion through which a portion of the seat belt is inserted, and
the belt anchor is fixed to the seat frame below the seat cutout portion.

20. A utility vehicle comprising:
a ROPS frame that defines an upper portion of a riding space;
a seat disposed in the riding space; and
a seat back disposed in the riding space,
wherein the ROPS frame includes a pair of left and right vertical frames extending in a vertical direction on an outer side in a vehicle width direction, and
an outer portion of the seat back in the vehicle width direction directly or indirectly abuts on the vertical frames.
